(19) United States
(12) Patent Application Publication
(10) Pub. No.: US 2024/0332525 A1
(43) Pub. Date: Oct. 3, 2024

(54) HIGH CAPACITY, HIGH ENERGY DENSITY AND HIGH POWER REVERSIBLE Li-Cl2 BATTERY SYSTEM

(71) Applicant: City University of Hong Kong, Hong Kong (HK)

(72) Inventors: Chunyi ZHI, Hong Kong (HK); Pei LI, Hong Kong (HK); Xinliang LI, Hong Kong (HK)

(21) Appl. No.: 18/193,640

(22) Filed: Mar. 31, 2023

(51) Int. Cl. H01M 4/58; H01M 10/0569; H01M 50/417; H01M 50/457

(52) U.S. Cl. CPC H01M 4/582; H01M 10/0569; H01M 50/417; H01M 50/457; H01M 2300/004

(57) ABSTRACT

The present invention provides a high capacity, high energy density and high power reversible Li—Cl₂ battery system. The battery system includes a halogen-based cathode, an anode, a separator placed between the halogen-based cathode and the anode, and an organic electrolyte disposed in a space between the halogen-based cathode and the anode. The halogen-based cathode includes at least one interhalogen compound statically adsorbed to a porous host electrode. The reversible Li—Cl₂ battery system can deliver a capacity of at least 200 mAh g⁻¹, an energy density in a range of 750-1100 Wh kg⁻¹, and a power density in a range of 1400-4500 Wh kg⁻¹ within a current density of 425 to 1250 mA g⁻¹.

### TECHNICAL FIELD

The present invention relates to a rechargeable battery system. More particularly, the present invention relates to a high capacity, high energy density and high power Li—Cl₂ battery with formation of reversible interhalogen bonds.

### BACKGROUND OF THE INVENTION

To date, facing the market with increasing demands for energy storage of electric vehicles and intermittent renewable sources at a low price, lithium-ion batteries (LIBs) are leading energy storage systems due to large energy density and power density. Alternative ways to further boost up energy density of LIBs have been intensively investigated. In principle, halogens Cl, Br, and I, are all suitable for high-energy batteries because the conversion reaction of halogens allows for a large amount of charge transfer. Furthermore, these materials are abundant and cheap, becoming a strong competitor. Br and I have been widely investigated¹⁻⁵.

Also, Li—Cl₂ conversion batteries, based on anionic redox reactions of Cl⁻/Cl⁰, are highly attractive due to superior voltage (about 3.8 V) and theoretical capacity (756 mAh g⁻¹). However, a redox-active and reversible chlorine cathode has not been developed in organic electrolytes-based lithium-ion batteries. The reasons are as follows: (1) Cl⁻ ions should be abundant and highly mobile in the electrolyte; (2) many Cl⁻-contained electrodes are not oxidizable due to the poor solubility of chlorine ions bonded by ionic bonding in the electrolyte, which imposes a thermodynamic barrier on the redox reactions; and (3) free oxidized Cl⁰ needs to be bonded to the electrode-electrolyte interface by using adsorbents and/or chemical/physical fixations, otherwise the Cl₂ generation will occur, resulting in the irreversibility. Typically, thermodynamically unstable gaseous Cl₂ is used as the cathode⁶⁻⁷, and thus cannot discharge on the electrode, posing a significant limitation to the general utility of the battery. From these points, the market of reversible chlorine cathode is not yet fully developed but still in its initial stage.

Graphite has been used as an anchoring material to stabilize Cl⁰ with the assistance of other halogen ions⁸⁻⁹. Another example of the reversible Cl^{0/-1} reaction in a battery is to deposit inorganic chloride compounds from the electrolyte during the first discharge in a carbon host¹⁰. The formation of a thin inorganic chloride layer is crucial for reversibility, but it is relatively inert and cannot fully release the Cl^{0/-1} reaction capacity. Besides, an intermediate material is needed for the reversible reaction of Cl^{0/-1}, which limits the prospect of chlorine cathodes to some extent.

Consequently, there is a need for developing a battery having a reversible chlorine cathode free of intermediates and capable of releasing the Cl^{0/-1} reaction capacity. The present invention addresses this need.

The following reference list sets forth the literature mentioned in this section, which are incorporated herein by reference in their entirety:
1. Ma. J., Liu. M., He. Y. & Zhang. J. Iodine redox chemistry in rechargeable batteries. Angew. Chemie.
2. Li. P. et al. Highly Thermally/Electrochemically Stable I⁻/I³⁻ Bonded Organic Salts with High I Content for Long-Life Li—I₂ Batteries. Adv. Energy Mater. 2103648 (2022).
3. Wang. F. et al. Fully Conjugated Phthalocyanine Copper Metal-Organic Frameworks for Sodium-Iodine Batteries with Long-Time-Cycling Durability. Adv. Mater. 32. (2020).
4. Zou. Y. et al. A four-electron Zn—I₂ aqueous battery enabled by reversible I⁻/=I₂/I⁺ conversion. Nat. Commun. 12, 1-11 (2021).
5. Huang. Z. et al. Small-Dipole-Molecule-Containing Electrolytes for High-Voltage Aqueous Rechargeable Batteries. Adv. Mater. 34, 2106180 (2022).
6. Manthiram. A. A reflection on lithium-ion battery cathode chemistry. Nat. Commun. 11, 1-9 (2020).
7. Carr. P., Symons. P. C. & Aller. D. J. Operational zinc chlorine battery based on a water store. (1979).
8. Yang. C. et al. Aqueous Li-ion battery enabled by halogen conversion-intercalation chemistry in graphite. Nature 569, 245-250 (2019).
9. Guo. Q. et al. Reversible Insertion of I—Cl Interhalogen in a Graphite Cathode for Aqueous Dual-Ion Batteries. ACS Energy Lett. 6, 459-467 (2021).
10. Zhu. G. et al. Rechargeable Na/Cl₂ and Li/Cl₂ batteries. Nature 596, 525-530 (2021).

### SUMMARY OF THE INVENTION

The present invention provides an interhalogen compound, iodine trichloride (ICl₃), as the cathode to address these issues, and a method for preparing such halogen cathode.

In a first aspect, the present invention provides a high capacity, high energy density and high power reversible Li—Cl₂ battery system. The system includes a halogen-based cathode, an anode, a separator placed between the halogen-based cathode and the anode, and an organic electrolyte disposed in a space between the halogen-based cathode and the anode.

In one embodiment, the halogen-based cathode includes at least one interhalogen compound including chlorine statically adsorbed to a porous host electrode. The porous host electrode contains at least one porous material, a plurality of electrically conductive particles, a binder and a current collector.

In one embodiment, the rechargeable Li—Cl₂ battery delivers a capacity of at least 200 mAh g⁻¹, an energy density in a range of 750-1100 Wh kg⁻¹, and a power density in a range of 1400-4500 Wh kg⁻¹ within a current density of 425 to 1250 mA g⁻¹.

In one embodiment, Cl⁻ ions are partially dissolved in the organic electrolyte, and Cl⁰ ions are efficiently and chemically anchored by forming interhalogen bonds with I, allowing for a Cl^{0/-1} reaction in a highly reversible manner. Anionic redox reactions would achieve a high capacity than typical transition-metal-oxide cathodes, offering a low-cost chemistry to advance the energy storage capability of lithium-ion batteries.

In one embodiment, the anode comprises Li plate or Li foil.

In one embodiment, the at least one porous material comprises activated carbon (YP50), templated carbons, carbide-derived carbons, carbon nanotubes, carbon aerogels, carbon onions, graphenes and carbon nanofibers.

In one embodiment, the at least one interhalogen compound comprises iodine trichloride (ICl₃).

In another embodiment, the organic electrolyte comprises one or more mixed solvent with or without additives.

Preferably, the organic electrolyte is ether-based electrolyte selected from the group consisting of monoglyme, diglyme, triglyme, tetraglyme, or mixed with a volume ratio of 1:1/1:2/1:3/1:4 in a glove box filled with Ar atmosphere.

In yet another embodiment, the organic electrolyte further contains one or more lithium salt as a solute. The one or more lithium salts is selected from the group consisting of LiTFSI, LiOTF, LiPF₆, LiClO₄, LiBF₄, LiAsF₆, and LiDFOB.

In another embodiment, the additives include LiF, LiNO₃, vinylene carbonate (VC), vinyl ethylene carbonate, allyl ethyl carbonate, or Lithium bis(oxalato) borate.

In one embodiment, the current collector is selected from the group consisting of carbon cloth, carbon paper, graphite paper, Ti foil/mesh, and stainless steel. They can stabilize with high-valence-state chlorine.

In one embodiment, the plurality of electrically conductive particles include carbon nanotubes, graphene, conductive carbon black, Super P, acetylene black, and carbon nanofibers.

In one embodiment, the binder includes styrene-butadiene rubber (SBR) and polyvinylidene fluoride (PVDF).

In one embodiment, the separator includes polypropylene/polyethylene/polypropylene (PP/PE/PP) separator, poly(tetrafluoroethylene) (PTFE), poly(vinyl chloride) (PVC) and polyamide (PA).

Preferably, the separator is multi-layers separator.

In a second aspect, the present invention also provides a method of constructing a halogen cathode, including:
step (a): mixing at least one porous material with a large Brunauer-Emmett-Teller (BET) surface area, a plurality of electrically conductive particles, and a binder in a solvent to form a first mixture;
step (b): coating the first mixture onto a current collector, and drying in a vacuum oven to construct a porous host electrode; and
step (c): sealing the porous host electrode and ICl₃ in a glass reactor filled with Ar atmosphere, and a ICl₃ cathode is obtained by static adsorption after 12 to 24 hours.

In one embodiment, the BET surface area is in a range of 1500 m² g⁻¹ to 2000 m² g⁻¹.

In one of the embodiments, the porous host electrode includes reduced graphene oxide, activated carbon, hollow carbon sphere, and carbon cloth.

ICl₃ loading is measured by subtracting the mass of the porous host electrode from the ICl₃ cathode, and up to 30 wt % to 90 wt %.

The present invention has the following advantages:
(1) The present invention is the first to develop a redox-active and reversible chlorine cathode in organic electrolytes.
(2) ICl₃ as a multi-redox halogen cathode exhibits high reversibility without using any intermediary materials.
(3) The rich chemistry of ICl₃ makes it possible to achieve multiple electron reaction and, therefore high capacity. In particular, the ICl₃ cathode exhibits outstanding performances with a specific capacity of 302 mAh g⁻¹ (based on the ICl₃ mass throughout this paper unless otherwise specified) at 425 mAg⁻¹ and an excellent rate capability (73.8% capacity retention at 1250 mA g⁻¹). It inspires the development of high-performance cathodes for rechargeable Li—Cl₂ batteries with high energy and power.
(4) The cathode materials based on conversion chemistry Cl₂/Cl⁻ are economical due to large theoretical capacity, high natural abundance and low cost.

### BRIEF DESCRIPTION OF THE DRAWINGS

In the following detailed description, reference is made to the accompanying figures, depicting exemplary, non-limiting and non-exhaustive embodiments of the invention. So that the manner in which the above recited features of the present invention can be understood in detail, a more particular description of the invention, briefly summarized above, can be had by reference to the embodiments, some of which are illustrated in the appended figures. It should be noted, however, that the figures illustrate only typical embodiments of this invention and are therefore not to be considered limiting of its scope, for the invention can admit to other equally effective embodiments.

FIG. 1A illustrates unblocked mass transfer of soluble Cl⁻¹ to Cl⁰ and reactions fixed at electrode;

FIG. 1B illustrates situations for Cl^{0/-1} redox reaction of insoluble inorganic chloride compounds (upper) and partially soluble organic chloride compounds (bottom);

FIG. 2A illustrates CV curves of a Li—LiCl cell without oxidation peak using 1 M bis-(trifluoromethane) sulfonimide lithium salt (LiTFSI) in DOL/DME electrolyte at 1 mV s⁻¹. The right panel shows the oxidation current density above 3.8 V;

FIG. 2B illustrates CV curves of a Li-TBACl cell without reduction peak using 1 M LiTFSI in DOL/DME electrolyte at 1 mV s⁻¹. The right panel shows the oxidation current density above 3.8 V;

FIG. 3 shows images of electrode morphologies and elemental mappings of ICl₃ with YP50;

FIG. 4 illustrates initial electrochemical CV curves of ICl₃ at the scan rate of 5 mV s⁻¹ (left) and galvanostatic charge/discharge at 0.3 mA from the first cycles (right);

FIG. 5 illustrates stabilized CV curve of a Li—Cl₂ battery in 1 M LiTFSI in DOL/DME electrolyte at 1 mV s⁻¹ according to an embodiment of the present invention. The right side is the calculated Gibbs free energy by first-principles density-functional theory (DFT) and the optimized reaction path (left side). Lewis structures of reaction products are also provided. The solid lines are the predicted products, and the two dotted lines represent less stable products;

FIG. 6 illustrates the discharge behavior of a Li—Cl₂ battery with three plateaus at 3.85 V, 3.40 V and 3.00 V, respectively;

FIG. 7 illustrates cyclic voltammetry profiles of the Li-YP50 battery using 1 M LiTFSI-Cl-containing or 1M LiTFSI electrolyte in DOL/DME at 2 mV s⁻¹;

FIG. 8 illustrates comparison of the theoretical redox chemistry of Cl and I in (left) aqueous system and organic system;

FIG. 9 illustrates Gibbs energy of intermediate products;

FIG. 10 illustrates Gibbs free energy predicted by first-principles density-functional theory (DFT) calculations and the optimized reaction path;

FIG. 11A illustrates G- and D-bands of activated carbon YP50 during CV measurements of FIG. 11B;

FIG. 11B illustrates CV measurements in the voltage range of 2.5 to 4.0 V at 0.5 mV s⁻¹ (left), and I—Cl band evolution of the charging process from 3.2 to 4.0 V and subsequent discharge to 3.2 V (right);

FIG. 11C illustrates G- and D-bands of activated carbon I₃⁻ during CV measurements of FIG. 11B;

FIG. 11D illustrates I₃⁻ and I—Cl band intensities as a function of battery voltage during the charging process;

FIG. 12 illustrates Raman spectra of electrolyte of (a) 1M LiTFSI in DOL/DME, (b) 0.5M ICl₃ in electrolyte and (c) 0.1M ICl₃ in electrolyte, and comparison of Raman spectra;

FIG. 13A illustrates high-resolution XPS spectra of I3d and Cl₂p for ICl₃ cathode at fully discharged states;

FIG. 13B illustrates high-resolution XPS spectra of I3d obtained ex-situ at various charging states. The intensities of the spectra are relative to each other;

FIG. 13C illustrates high-resolution XPS spectra of Cl2p obtained ex-situ at various charging states. The intensities of the spectra are relative to each other;

FIG. 14A illustrates CV curves of a Li—Cl₂ battery at different scan rates from 0.2 to 1 mV s⁻¹ (upper panel) and 2 to 5 mV s⁻¹ (bottom panel);

FIG. 14B illustrates galvanostatic charge/discharge profiles of the Li—Cl₂ battery at different current densities, and capacity contribution of each discharge plateau under different charging/discharging rates. The overall capacity is normalized to 1;

FIG. 14C illustrates long-term cycling performance of the Li—Cl₂ battery at 750 mA g⁻¹;

FIG. 14D illustrates comparison of operation voltage among various cathodes for lithium batteries using organic electrolytes. Data are taken from: lithium manganese oxide (LiMn₂O₄), LiCoO₂, NMC, lithium nickel cobalt aluminum oxides (NCA88), lithium iron phosphate (LiFePO₄)₁₆, Br⁵², I⁵³;

FIG. 15 illustrates linear fits of reduction and oxidation peak currents with the square root of sweeping rate;

FIG. 16 illustrates specific capacity under different charging/discharging rates at every plateau; and

FIG. 17 illustrates capacity contribution (point) and corresponding energy density (column) of every discharge plateau. The total energy density is 1024 Wh kg⁻¹ based on the mass of ICl₃.

### DETAILED DESCRIPTION

The present invention will be described in detail through the following embodiments with appending drawings. It should be understood that the specific embodiments are provided for an illustrative purpose only, and should not be interpreted in a limiting manner. Those skilled in the art will appreciate that the invention described herein is susceptible to variations and modifications other than those specifically described.

The invention includes all such variation and modifications. The invention also includes all of the steps and features referred to or indicated in the specification, individually or collectively, and any and all combinations or any two or more of the steps or features. Other aspects and advantages of the invention will be apparent to those skilled in the art from a review of the ensuing description.

Due to their lower molar mass and higher discharge plateau I Br, and Cl redox cathodes can deliver a higher theoretical capacity and energy density than conventional cathodes. However, until recently, reversible chlorine redox reactions have never been developed in organic electrolyte-based batteries due to the lack of a reversible cathode. The present invention provides a battery using an interhalogen compound iodine trichloride (ICl₃) as the cathode to meet the demands for energy storage at a lower price than lithium-ion batteries.

First, the present invention provides a high capacity, high energy density and high power reversible Li—Cl₂ battery system. The system includes a halogen-based cathode, an anode, a separator placed between the halogen-based cathode and the anode, and an organic electrolyte disposed in a space between the halogen-based cathode and the anode. The system further includes at least one interhalogen compound including chlorine statically adsorbed to a porous host electrode. The porous host electrode contains at least one porous material, a plurality of electrically conductive particles, a binder and a current collector. The present invention realizes the redox-activity primarily in the organic electrolytes.

The rechargeable Li—Cl₂ battery system delivers a high capacity, a high energy density and a high power. More specifically, at the current density of 425 mA g⁻¹, the reversible Li—Cl₂ battery system has a specific capacity of 302 mAh g⁻¹, an energy density of 1024.2 Wh kg⁻¹ and a power density of 1441.341 Wh kg⁻¹. At the current density of 500 mA g⁻¹, at least 98.3% of capacity is retention, and the battery system has a specific capacity of 297 mAh g⁻¹, an energy density of 1010.1 Wh kg⁻¹ and a power density of 1700.505 Wh kg⁻¹. At the current density of 625 mA g⁻¹, at least 94.3% of capacity is retention, and the battery system has a specific capacity of 285 mAh g⁻¹, an energy density of 959.65 Wh kg⁻¹ and a power density of 2104.496 Wh kg⁻¹. At the current density of 750 mA g⁻¹, at least 89.7% of capacity is retention, and the battery system has a specific capacity of 271 mAh g⁻¹, an energy density of 907.1 Wh kg⁻¹ and a power density of 2510.424 Wh kg⁻¹. At the current density of 1250 mA g⁻¹, at least 73.8% capacity is retention, and the battery system has a specific capacity of 223 mAh g⁻¹, an energy density of 753.75 Wh kg⁻¹ and a power density of 4225.056 Wh kg⁻¹.

The reduced Cl-ions are partially dissolved in the organic electrolyte, facilitating oxidation via a liquid-solid pathway. The oxidized Cl⁰ is efficiently and chemically anchored by forming interhalogen bonds with I and hence allows for the Cl^{0/-1} reaction in a highly reversible manner. The reversible reaction can be carried out at room temperature. The breakage and reformation of interhalogen bonds between I and Cl are highly reversible, allowing for good cycling stability of 200 cycles.

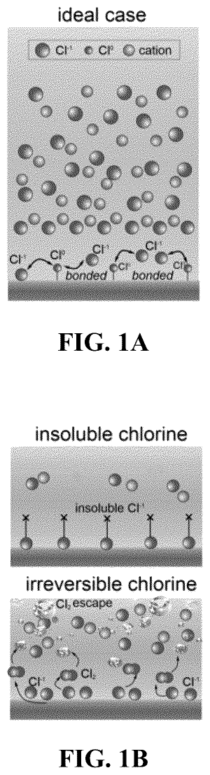

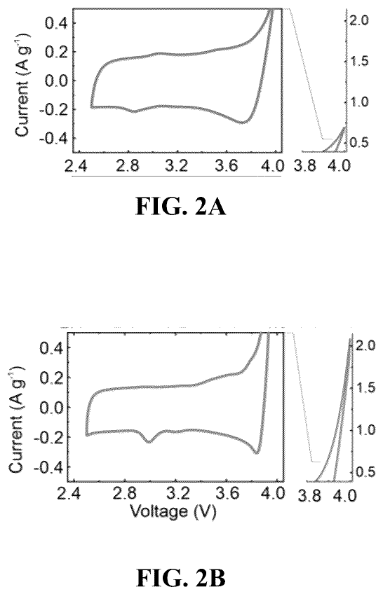

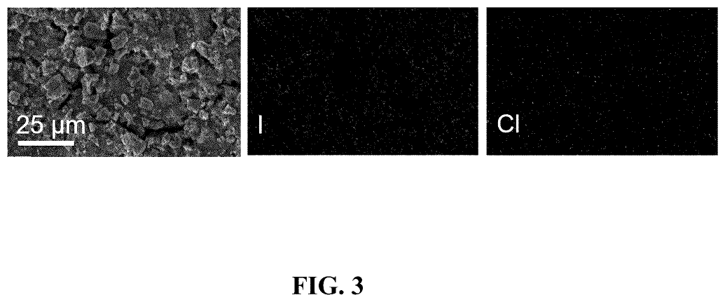

FIG. 1A shows unblocked mass transfer of soluble Cl⁻¹ to Cl⁰ and reactions fixed at electrode, which is an ideal situation for Cl^{0/-1} redox reaction (exemplified by dimethoxyethane (DME) and dioxolane (DOL) electrolytes). In terms of the mobile chlorine ions, inorganic chloride compounds (e.g., lithium chloride (LiCl) or sodium chloride (NaCl)) are almost completely insoluble in organic electrolytes (FIG. 1B, upper). The insolubility of chloride compounds will lead to very low Cl⁻¹ concentration in electrolytes, impeding the Cl^{0/-1} redox reaction. In addition, the solid-state mass transfer from chloride compounds to Cl⁰ is thermodynamically unrealistic. Some organic chloride compounds, such as tetrabutylammonium chloride (TBACl), can partially dissolve in the electrolyte and provide Cl⁻ for redox reactions. However, unbonded Cl⁰ generates gaseous Cl₂, resulting in the loss of active materials and limited reversibility (FIG. 1B, bottom). A clear demonstration showing the inactivity of inorganic chloride compounds is exhibited in FIG. 2A. The CV curves of Li—LiCl cell show that no oxidation peak of Cl-occurs during the cyclic voltammetry (CV) test, and neither does the reduction peak. Only a capacitive behavior can be identified. In contrast, the CV curves of Li-TBACl cell show that an intense oxidation polarization could be observed in the CV curve as the current density after 3.8 V increases dramatically. However, a reduction peak is still missing, implying the escape of Cl⁰ (FIG. 2B).

In one embodiment, the anode may include, but is not limit to, a Li plate or Li foil. The use of lithium metal anodes increases the overall energy density of the battery.

In one of the embodiments, the at least one porous material may include, but not limit to, activated carbon (YP50), templated carbons, carbide-derived carbons, carbon nanotubes, carbon aerogels, carbon onions, graphenes and carbon nanofibers.

Preferably, the at least one interhalogen compound is iodine trichloride (ICl₃).

In one of the embodiments, the organic electrolyte can be one or more mixed solvent with or without additives. The additives are expected to include, but not limit to, LiF, LiNO₃, vinylene carbonate (VC), vinyl ethylene carbonate, allyl ethyl carbonate, or Lithium bis(oxalato) borate.

Preferably, the organic electrolyte is ether-based electrolyte, which may include, but not limit to, monoglyme, diglyme, triglyme, tetraglyme, or mixed with a volume ratio of 1:1/1:2/1:3/1:4 in a glove box filled with Ar atmosphere.

Moreover, the organic electrolyte includes one or more lithium salt as a solute. The one or more lithium salt may include, but not limit to, LiTFSI, LiOTF, LiPF₆, LiClO₄, LiBF₄, LiAsF₆, and LiDFOB.

In one of the embodiments, the current collector may include, but not limit to, carbon cloth, carbon paper, graphite paper, Ti foil/mesh, and stainless steel.

In one of the embodiments, the plurality of electrically conductive particles are expected to include, but not limit to carbon nanotubes, graphene, conductive carbon black, Super P, acetylene black, and carbon nanofibers.

In one of the embodiments, the binder may include, but not limit to, styrene-butadiene rubber (SBR) and polyvinylidene fluoride (PVDF).

The present invention also provides a method of constructing a halogen cathode:
step (a): mixing at least one porous material with a large Brunauer-Emmett-Teller (BET) surface area, a plurality of electrically conductive particles, and a binder in a solvent to form a first mixture;
step (b): coating the first mixture onto a current collector, and drying in a vacuum oven to construct a porous host electrode; and
step (c): sealing the porous host electrode and ICl₃ in a glass reactor filled with Ar atmosphere, and a ICl₃ cathode is obtained by static adsorption after 12 to 24 hours.

In one embodiment, the BET surface area is in a range of 1500 m² g⁻¹ to 2000 m² g⁻¹. For instance, the BET surface area can be at least 1500 m² g⁻¹, at least 1600 m² g⁻¹, at least 1700 m² g⁻¹.

In one embodiment, the porous host electrode may include, but not limit to, reduced graphene oxide, activated carbon, hollow carbon sphere, and carbon cloth.

ICl₃ loading is measured by subtracting the mass of the porous host electrode from the ICl₃ cathode, and up to 30 wt % to 90 wt %. For instance, the ICl₃ loading is up to 30 wt %, up to 40 wt %, up to 50 wt %, up to 60 wt %, up to 70 wt %, up to 80 wt %, or up to 90 wt %.

In the step (b), the drying condition is a temperature range of 60-80° C. for at least 24 hours.

### EXAMPLES

The examples and embodiments described herein are for illustrative purposes only and various modifications or changes in light thereof will be suggested to persons skilled in the art and are included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### Example 1

### Sources of Materials for Chemicals and Battery Components

All chemicals are used directly without any post-treatment. Iodine trichloride (ICl₃, 97%, Aladdin; the impurity is excessive iodine that does not form compound with chlorine according to stoichiometric ratio during preparation process), Lithium chloride (LiCl, 99.9%, Aladdin), Tetrabutylammonium chloride (TBACl, ≥99.0%, Aladdin), Sodium chloride (NaCl, 99.9%, Aladdin), iodine (12, 99.5%, Aladdin), activated carbon (YP50, Kuraray Chemical), bis (trifluoromethane) sulfonimide lithium salt (LiTFSI, 99%, Aladdin), ethanol (C₂H₅OH, 99.5%, Aladdin), dimethoxyethane (DME, 99%, Aladdin), dioxolane (DOL, 99%, Aladdin), Ethylene carbonate (EC, 99%, Aladdin), Dimethyl carbonate (DMC, 99%, Aladdin), Ethyl Methyl Carbonate (EMC, 99%, Aladdin), Diethyl carbonate (DEC, 99%, Aladdin), Propylene carbonate (PC, 99.7%, Aladdin), poly(vinylidene 470 fluoride) (PVDF, average Mw ˜400000, Aladdin), nmethyl-2-pyrrolidone (NMP, 99%, Aladdin), ketjenblack (KB, ECP-600JD, Lion Corporation).

### Equipment for Characterizing the Physical and Chemical Properties of Materials

The morphology and microstructure were characterized by the cold field emission scanning electron microscope (SEM; SU4800, Hitachi). Raman spectroscopy (WITec alpha300 access) equipped with a laser of 532 nm wavelength was performed to record the chemical changes. A buttom cell with a quartz window on the positive shell was used for in situ Raman spectroscopy analysis. X-ray photoelectron spectroscopy (XPS; ESCALAB 250) was conducted to analyze surface compositions. Nitrogen adsorption measurement was conducted at 77 K using a Micromeritics ASAP 2460 instrument (Micromeritics Instrument Corp., America). Pore volume was calculated at a relative pressure P/P0=0.990, the specific surface area was obtained by Brunauer-Emmett-Teller (BET) analyses of the adsorption isotherm and the pore size distribution was calculated using density functional theory (DFT).

### Electrochemical Measurements

The CR2032 coin-type battery was assembled for electrochemical measurements. Galvanostatic charge/discharge profiles were recorded by LAND CT2001A battery testing device. CHI 760E multichannel electrochemical workstation was employed to record the cyclic voltammetry (CV) and electrochemical impedance spectroscopy (EIS) data. Li foil was used as the anode. Specific capacities were calculated based on the mass of iodine trichloride.

### Example 2

### Example 2-1

### Preparation of I₂ Electrode

I₂@AC was prepared through a melt-diffusion method. The YP50 was mixed with acetylene black and poly (vinylidene fluoride) at a weight ratio of 8:1:1 and then coated onto carbon cloth (CC). After drying in a vacuum oven, the YP50 disk and iodine were put into a stainless reactor. Then the reactor was then sealed and heated to 135° C. for 12 h.

### Example 2-2

### Preparation of TBACl, LiCl and NaCl Electrodes

The YP50 disks were prepared as described in the preceding examples. For Air sensitive TBACl or LiCl, TBACl or LiCl was dissolved in alcohol and the solution was dropped onto the YP50 electrodes using a pipet. Filling TBACl/LiCl was repeated several times. The electrodes were then heated at 150° C. for 1 h. For the NaCl cathode, NaCl, ketjenblack (KB) and PVDF were mixed in N-Methylpyrrolidone solvent with a mass ratio of 8:1:1, followed by vigorously stirring for 20 minutes. Then, the slurry was coated to a titanium foil and dried at 70° C. in a vacuum oven for 24 h.

### Example 2-3

### Preparation of ICl₃ Cathode

To fabricate a ICl₃ cathode, the present invention used porous materials such as activated carbon (YP50) with a large Brunauer-Emmett-Teller (BET) surface area (1742 m² g⁻¹) to host the ICl₃, which offers abundant sites for the Cl^{-1/0} redox reaction.

YP50 powder, ketjenblack (KB), and PVDF were mixed in N-Methylpyrrolidone solvent with a mass ratio of 8:1:1, followed by vigorously stirring for 20 minutes. Next, the slurry was coated on a titanium foil, and dried at 70° C. in a vacuum oven for 24 h. Then YP50 disks and ICl₃ were put into a glass reactor in a glove box filled with Ar atmosphere. The reactor was then sealed for static adsorption for 12 h. ICl₃ loading (˜70 wt %) was measured by subtracting the mass of pure YP50 from the YP50 with ICl₃ loading.

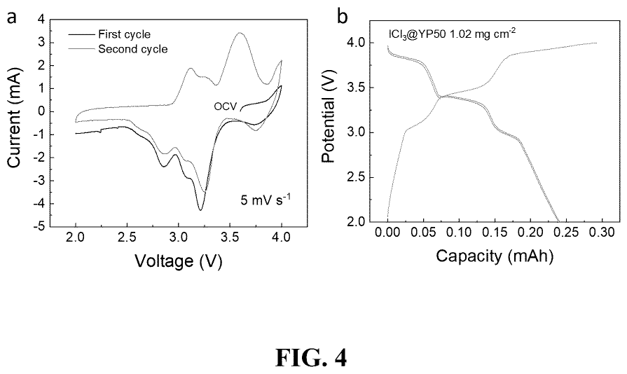

SEM images and the corresponding elemental mapping (FIG. 3) demonstrated evenly distributed ICl₃ in micropores of the YP50. The open circuit voltage (OCV) of the ICl₃ cathode is about 3.5 V. No peaks were observed during the first anodic sweep from the (OCV) to 4.0 V (FIG. 4) because I and Cl atoms are strongly bonded by halogen bonds, showing no reactivity as a compound.

### Example 3

### Preparation of Ether Electrolyte

Due to the oxidative properties of high-valence I and Clin ICl₃, it can react with various ester electrolytes having superior stability. The ether electrolyte was fabricated by dissolving 1 M lithium LiTFSI salts and trace LiCl (<0.05M) into the mixture of DOL and DME solvents with a volume ratio of 1:1 in a glove box filled with Ar atmosphere. The ether electrolyte used was fabricated by dissolving 1 M lithium LiPF₆ salts into the mixture of EC, DMC and EMC solvents with a volume ratio of 1:1:1 in a glove box filled with Ar atmosphere.

### Example 4

Preparation of a Button Cell with ICl₃ Cathode

In this example, a battery is assembled using the ICl₃ (in AC) as the cathode and a lithium foil as the anode in a button cell. Polypropylene/polyethylene/polypropylene (PP/PE/PP) three-layer separator (Celgard 2325) soaked with LiTFSI in the ether-based electrolyte is sandwiched by the two electrodes. The as-fabricated Li—Cl₂ batteries can exhibit high energy density with stable and multiple output potential and good cycling stability in organic electrolytes.

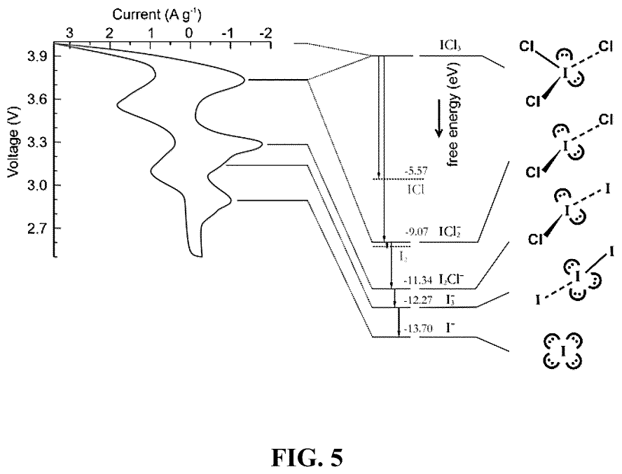

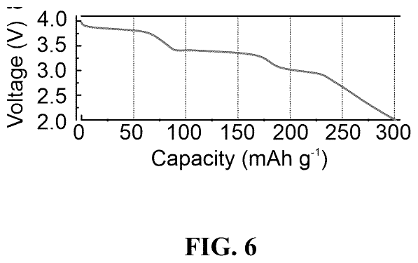

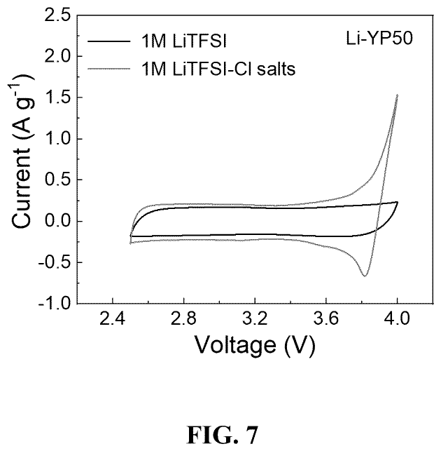

In one embodiment, FIG. 5 shows the stabilized CV curve of a Li—Cl₂ battery in 1 M LiTFSI in DOL/DME electrolyte at 1 mV s⁻¹. During the cathodic sweep, three prominent peaks at 2.9, 3.3, 3.8 V and a shoulder peak at 3.2 V were recognized. By contrast, the pure I₂ electrode only has a cathodic peak at around 2.8 V, which is attributed to the reduction of I₃⁻ to I⁻, indicating that the redox reaction of I⁻ ions is also activated. Correspondingly, the other three peaks are attributed to the Cl-induced reactions. The galvanostatic charge/discharge profile of the Li—Cl₂ battery (FIG. 6) showed three discharge plateaus at 3.85, 3.4 and 3.0 V, consistence with three prominent peaks in the CV curve as reported by Li et al., corresponding to Cl⁰/Cl⁻¹, I⁺/I⁰, I₃⁻/I⁻¹, respectively (L I, Xinliang, et al. Angewandte Chemie, 2022, 134.9: e202113576). The discharge voltage at 3.85 V in the Li—ICl₃ battery was in agreement with the Cl^{0/-1} (FIG. 7).

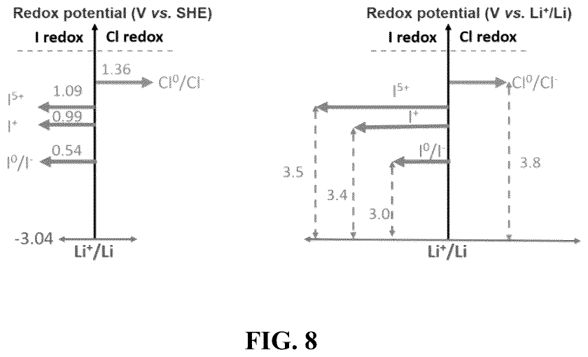

Besides, to clarify the redox potential of I and Cl, practical voltages of Cl⁰, I⁺ and I⁰ in organic system were also tested, this is corresponding to standard reduction potentials and experimental results of the present invention (FIG. 8). In specific, the ICl₃ electrode delivered a capacity of 302 mAh g⁻¹. The reduction of I₃⁻ to I⁻ (plateau at 3.0 V) contributed about ⅙ of the capacity, while the other two main plateaus offered about ⅔ of the capacity, showing the Cl-induced reactions were the primary source of the capacity.

### Example 5

### Density Functional Theory (DFT) Calculations

First-principle density-functional theory (DFT) calculations were employed to predict the conversion path and structural evolution of the ICl₃. All the computations were conducted based on the DFT using the Cambridge Sequential Total Energy Package (CASTEP) code of the Materials Studio software. The generalized gradient approximation (GGA) with the Perdew-Burke-Ernzerhof (PBE) functional were used to describe the electronic exchange and correlation effects. The kinetic-energy cutoff was set as 500 eV. The geometry optimization within the conjugate gradient method was performed with forces on each atom less than 0.05 eV/Å.

Additionally, the converge thresholds for energy and force were set to 10⁻⁵ eV and 0.02 eV/Å, respectively. Brillouin zone was sampled by a k-point mesh of 1×1×1. We computed the Gibbs free energy change (ΔG) of intermediates to predict the reaction path. The ΔG was calculated as:

$$Δ G = E ( gse ) + E ( zpe ) - T Δ S$$

where E(gse), E(zpe) and TΔS were the ground-state energy, zero-point energy and entropy term, respectively, with the latter two taking vibration frequencies from the density functional theory (DFT) calculation. T is set to 298.15 K. The free-energy (ΔG) of different intermediates were also defined as:

$$Δ G = E ( intermediate ) - E ( reactant )$$

where the E(intermediate) was the energy of intermediates and E(reactant) was the total energy of reactants ICl₃.

As the last cathodic peak (2.8 V) was identified as the reduction of I³⁻ to I⁻, the end products were I⁻ and Cl⁻, implying that the halogen bonds by sharing the lone-pair electrons of I and Cl in the ICl₃ compound were broken. The Gibbs free-energy (ΔG) for extracting Cl⁻ from ICl₃ was calculated. Either forming ICl or ICl₂⁻ was possible for the first reduction step. From the thermodynamic point of view, forming ICl₂⁻ was more likely because its ΔG (−9.07 eV) was much larger than for the ICl formation. In addition, the electrostatic potential of the ICl₂⁻ was balanced, confirming the existence of ICl₂⁻ as intermediate products. The extracted Cl from ICl₃ accepted two electrons, inducing the first reduction peak.

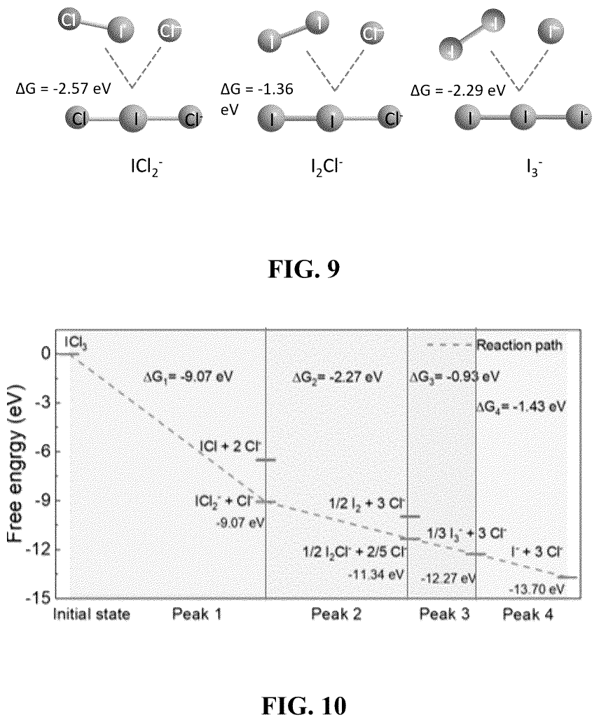

Next, the formation of I₂Cl⁻ was preferable because the ΔG for I₂Cl⁻ was larger than that of I₂. A fast transition to I₃⁻ would be expected since the ΔG from I₂C¹⁻ to I₃⁻ was very small (−0.93 eV). Furthermore, the electrostatic potential structure of I₂Cl⁻ was less stable than I₃⁻ (FIG. 9). This also supports the assumption of the fast change to I₃⁻. Such prediction can be evidenced by the shoulder peak corresponding to the transition from I₂C¹⁻ to I³⁻ at 3.2 V in FIG. 5.

Through the reduction from ICl₂⁻ to I₃⁻, two more Cl⁻ ions were released from the ICl₃, indicating Cl atoms accepted two more electrons. The final step was a typical reduction reaction of I₃⁻ and I⁻. The last two reaction steps (I−/I₃⁻/I⁰) contributed a capacity of 70 mAh g⁻¹, which could be calculated from the discharge profile before the second voltage plateau. Detailed ΔG of the reactions is shown in FIG. 10.

The discharging process of the ICl₃ electrode is speculated as four steps:

$$step 1 : {ICl}_{3} + 2 {e}^{-} \to {ICl}_{{2}^{-}} + {Cl}^{-} \qquad ( 1 )$$

$$step 2 : {ICl}_{{2}^{-}} + {Cl}^{-} + {e}^{-} \to 1 / 2 {I}_{2} {Cl}^{-} + 5 / 2 {Cl}^{-} \qquad ( 2 )$$

$$step 3 : 1 / 2 {I}_{2} {Cl}^{-} + 5 / 2 {Cl}^{-} + 1 / 3 {e}^{-} \to 1 / 3 {I}_{{3}^{-}} + 3 {Cl}^{-} \qquad ( 3 )$$

$$step 4 : 1 / 3 {I}_{{3}^{-}} + 3 {Cl}^{-} + 2 / 3 {e}^{-} \to {I}^{-} + 3 {Cl}^{-} \qquad ( 4 )$$

### Example 6

### In Situ Raman Measurements

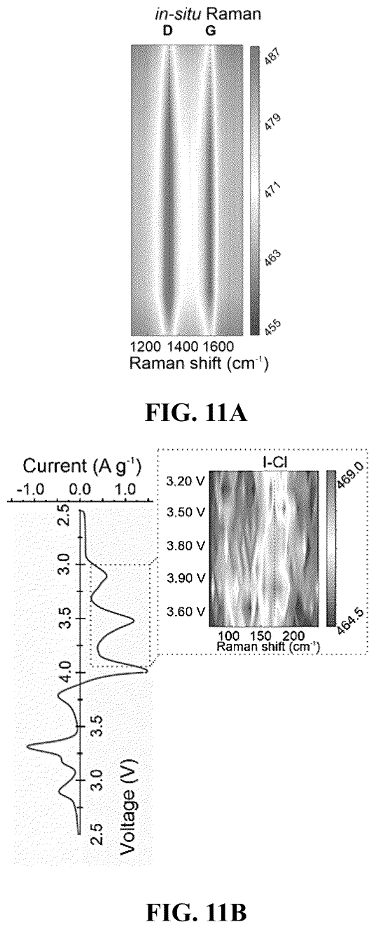

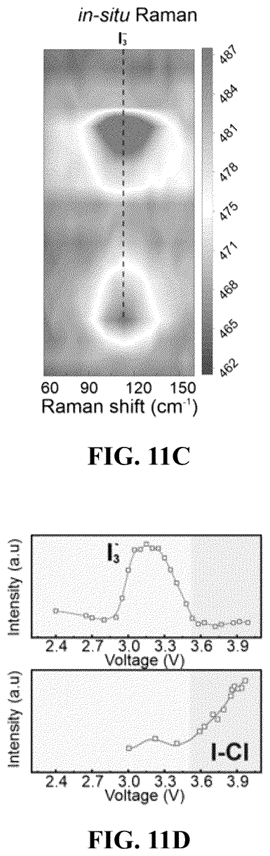

To further explore the conversion mechanism, in situ Raman measurements were performed. FIG. 11A shows the G- and D-band change of the YP50 during the CV measurement at a scan rate of 0.5 mVs⁻¹ according to FIG. 11B. As the voltage increased, the widths of the G- and D-band of the YP50 increased at the same time. This indicates an efficient electronic conductive network is constructed, where ICl₃ can gain or lose electrons on the large-surface-area surface and thus support fast charge transfer of its redox.

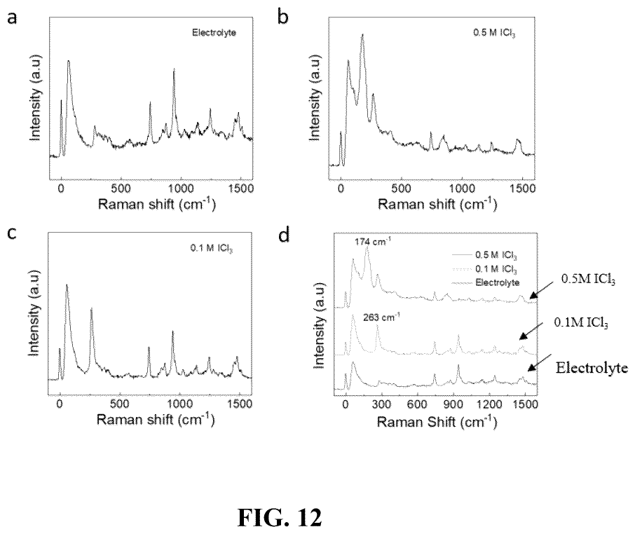

Turning to FIG. 11C, I₃⁻ species showed a characteristic stretching band at 110 cm⁻¹. During the anodic sweep, I₃⁻ species were detected after the voltage reaches 3.0 V. The first anodic peak in the voltage range of 3.0 to 3.2 V was attributed to the oxidation of I⁻ to I₃⁻. I₃⁻ species disappeared when the voltage exceeds 3.5 V, implying that the second anodic peak from 3.5 to 3.8 V stems from the interhalogen reformation. From 3.5 to 4.0 V, a new stretching band at 174 cm⁻¹ was found (FIG. 11B, right side), which corresponds to the interhalogen bond between I and Cl. The same stretching band was detected by dissolving ICl₃ into 1 M LiTFSI in DOL/DME (FIG. 12).

Turning to FIG. 11D, which shows a clear sequence of halogen oxidation. The intensity of the I₃⁻ band increased when the battery was charged from 2.5 V to 3.15 V, at which it reached the highest value. As the charging process continued, I₃⁻ band intensity gradually decreased and almost disappeared at 3.48 V due to the formation of the I—Cl interhalogen bond at 3.54 V.

The intensity of the I—Cl band increases with charging, indicating that free Cl⁻ species are bound to I via interhalogen bonds. Anchoring the oxidized Cl⁻ to I is crucial for redox reversibility, otherwise oxidized Cl⁻ would form gas and thus escape, as shown in bottom of FIG. 1B. The reformation of ICl₃ due to the strong interhalogen bond induces the highly reversible Cl^{0/-1} redox reaction.

### Example 7

### XPS Characterization of ICl₃ Redox Reaction

The interhalogen bonds between I and Cl were further evidenced by X-ray photoelectron spectroscopy (XPS), which reveals the valence state change of I and Cl at different voltages.

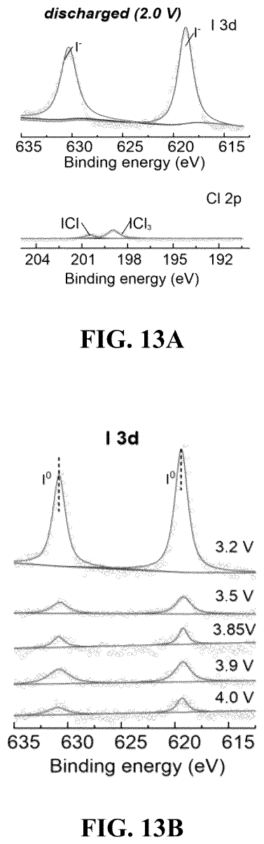

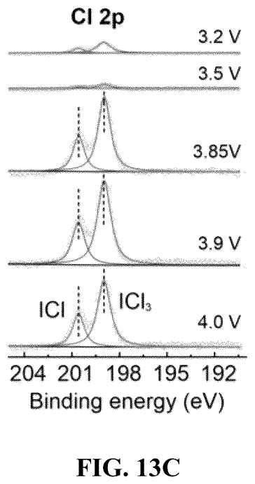

Turning to FIGS. 13A, I 3d peaks are much stronger than that of Cl 2p at a fully discharged state of 2.0 V, which suggests that Cl is largely dissolved in the electrolyte, approaching the ideal case for the Cl^{0/-1} redox reaction that Cl⁻¹ is mobile for efficient utilization. In addition, FIG. 13A also confirmed the final discharge product of I⁻ as I3d_{3/2} (630.1 cV) and I3d_{5/2} (618.6 eV) are assigned to I⁻. Meanwhile, it also observed residual bonded Cl with I, that is, ICl at about 200.5 eV and ICl₃ at about 199.0 eV. On the one hand, the residual ICl and ICl₃ indicated strong interhalogen bonding, which facilitated the Cl fixation during oxidation.

Turning to FIG. 13B, various charging states were tested. After charging to 3.2 V, I in a neutral valance state was observed, and its position was stable in the subsequent charge process. The formation of I in the neutral valance state was consistent with the interpretation from the Raman spectra that the first oxidation peak was attributed to the oxidation of I-species.

As the charging continued, a pair of strong peaks stemming from the interhalogen bonded I and Cl (ICl and ICl₃) were observed (FIG. 13C). At the same time, the relative intensity of I was weakened, indicating the dominance of the interhalogen compounds after the reaction. These results suggest the reformation of interhalogen compounds during the second oxidation peak.

Both Raman and XPS spectra demonstrate the reversibility of breakage and reformation of interhalogen bonds, which allows for the mobile Cl⁻ for efficient redox reaction and inhibits the escape of Cl⁰ in the form of Cl₂ gas.

### Example 8

### Performance and Comparison on Li—Cl₂ Battery

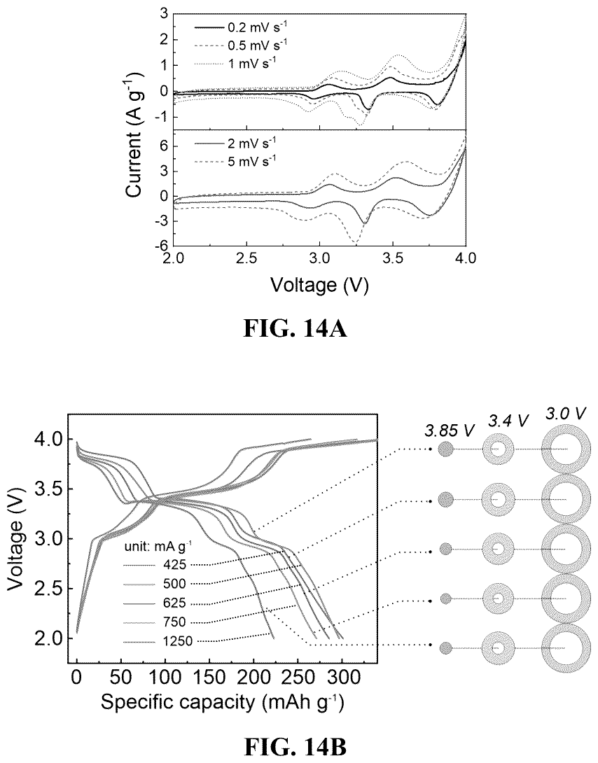

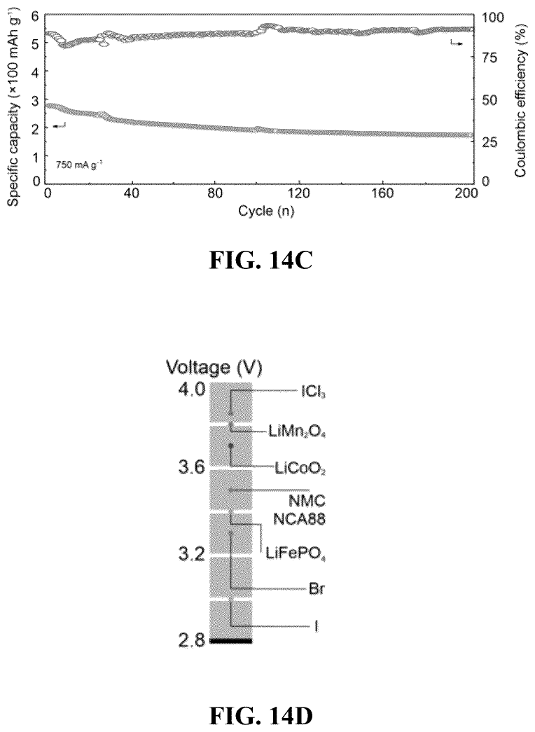

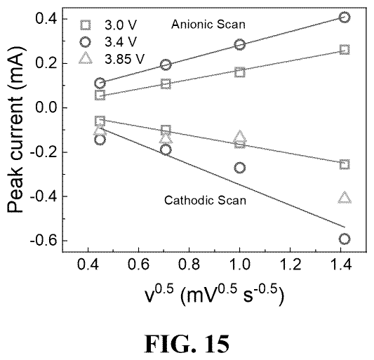

FIG. 14A shows CV curves at various scan rates, from 0.2 to 5 mV s⁻¹. When the scan rate was less than 1 mV s⁻¹, three prominent and one shoulder peaks were observed. However, the shoulder peak merged into a broad peak at around 3.3 V at the scan rate larger than 1 mV s⁻¹, indicating the limited I₃⁻ formation. As a result, the reduction peak assigned to I₃⁻ reduction became weaker as the scan rates increased. In specific, at 1 mV s⁻¹, the capacity contribution of I₃⁻ reduction (2.8 V) was 0.35, whereas the contribution decreased to 0.26 at 2 mV s⁻¹. In addition, the position of cathodic peaks shifted to lower potentials. On the other hand, two anodic peaks were always observable while their positions moved to higher potentials as scan rate increased. The expansion of the potential difference between cathodic and anodic peaks demonstrates the kinetic limitation of the reversible halogen conversions. Oxidation peak currents exhibit good linearity with the square root of scan rates (FIG. 15). Thereby, the oxidation process is controlled by the diffusion of halogen ions in the pores of the YP50, where a large specific area for redox is provided and shuttling of intermediates (polyiodides and chloriodides) is limited (Table 1). The diffusion-controlled process can also be identified for the first cathodic peak (3.85 V). Nevertheless, the kinetics of the following reduction process is complex because the linear relationship deviates substantially at high scan rates.

TABLE 1
Reported cathodes of lithium-ion batteries

| | Cathode | Plateaus(V). | Capacity |
|---|---|---|---|
| Type | materials | Li⁺/Li | (mAh g⁻¹) |
| Intercalation-type | LiCoO₂ | 3.7 | 140 |
| | LiMn₂O₄ | 3.8 | 148 |
| | LiFePO₄ | 3.4 | 170 |
| | LiNi_{0.6}Co_{0.2}Mn_{0.2}O₂ | 3.5 | 190 |
| | (NCM622) | | |
| | LiNixCoyAlzO₂ | 3.5 | 219.8 |
| | (NCA88) | | |
| | Li[LizTM1-z]O₂ | 3.8 | 250 |
| | (Li2MnO₃) | | |
| Conversion-type | I₂ | 3.0 | 197 |
| | Br₂ | 3.3 | 89(309 in theory) |

FIG. 14B shows the galvanostatic charge/discharge profiles at different current densities. At a low current density (425 mA g⁻¹), a high specific capacity of 302 mAh g⁻¹ was achieved. When the current density increased by around 3 times (1250 mA g⁻¹), the capacity was retained at 223 mAh g⁻¹, indicating excellent rate performance.

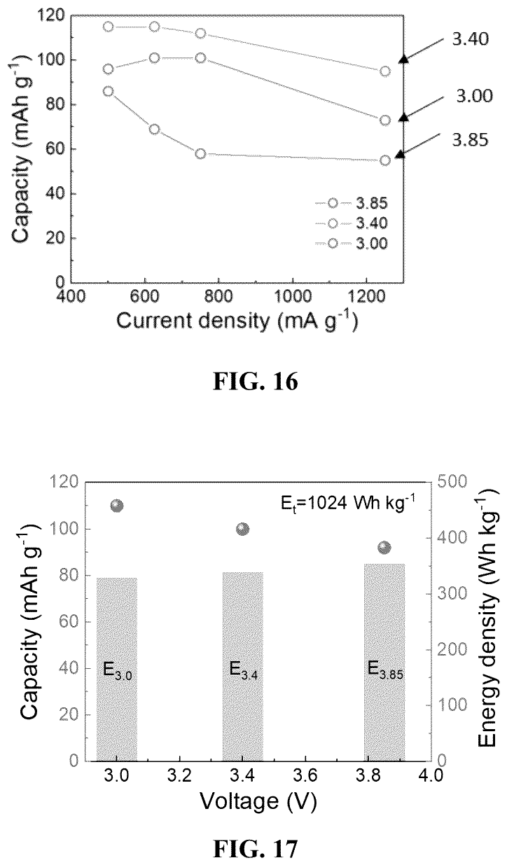

More importantly, three characteristic discharge plateaus were observed at all current densities. The right side of FIG. 14B compares the capacity contributions of these three discharge plateaus at different current densities. The overall capacity was normalized to 1. Turning to FIG. 16, A noticeable decrease in capacity contribution from the 3.85 V plateau was observed when the current density reached 625 mA g⁻¹, revealing that the kinetic extraction of the first Cl from ICl₃ was slower than the other reactions. As the current density increases to 1250 mA g⁻¹, the I₃⁻ reduction is limited. By contrast, the intermediate processes (3.4 V plateau) were relatively independent of the current density. This suggests that the process from ICl₂⁻ to I₃⁻ is fast both kinetically and thermodynamically. Benefit from high voltage, the redox conversion at 3.85 V provides the highest energy density in comparison with the other two voltage plateaus (FIG. 17).

The cycling of Li—Cl₂ battery was carried out at a current density of 750 mA g⁻¹. Turning to FIG. 14C, a reversible discharge capacity of 271 mAh g⁻¹ was obtained, and 64% of this initial capacity was retained over 200 cycles. The two key reasons that cause capacity loss are shuttling effect, indicating by the low coulombic efficiency shown in FIG. 14B, and unstable solid-electrolyte and cathode-electrolyte interphase.

The ICl₃ marks the highest attainable working voltage among cathode materials for lithium-ion batteries (FIG. 14D). The maximum working voltage of the ICl₃-based battery is about 3.85 V, much higher than the I₂ (3.0 V) and Br₂ (3.3 V) based batteries. Besides, the improved performance against conventional halogen-based lithium-ion batteries (I₂ and Br₂), the ICl₃ cathode demonstrates superior performance beyond the conventional cathode materials of lithium-ion batteries.

It is worth noting that the voltage of the ICl₃ based batteries is even slightly higher than for LiMn₂O₄, which is well-known for its high operating voltage. The performance of the ICl₃ electrode to other reported cathode materials was compared, as shown in Table 2. Porous carbonaceous hosts are common materials to solve the shuttling effect, and YP50 is comparable to various hosts reported in literatures in term of surface area.

TABLE 2
Reported porous hosts for Metal-halogen batteries

| | | | BET surface | |
|---|---|---|---|---|
| Battery | Cathode | Host | area of host | |
| type | materials | materials | (m² g⁻¹) | Note |
| Li—Cl₂ | ICl₃ | YP50 | 1742 | The present |
| | | | | invention |
| Li—I₂ | LiI | Meso-micro porous | 1303 | Prior art |
| | | carbon polyhedron | | |
| | | (MCP) | | |
| Li—Br | LiBr | A carbon coated | 1314 | Prior art |
| | | membrane (CCM) | | |
| Zn—I₂ | I₂ | Activated carbon | 1040 | Prior art |
| | | cloth (ACC) | | |
| I₂—C | I₂ | hierarchically | 1487 | Prior art |
| | | porous carbon | | |
| | | matrix co-doped | | |
| | | with nitrogen | | |
| | | and phosphorus | | |
| | | (HPCM-NP) | | |
| Li—I₂ | I₂ | N doped carbon | 1750 | Prior art |
| | | sphere | | |

Owing to the limited one-electron transfer, capacity of I₂ is much lower than the ICl₃ based batteries. At a high-power density of 4225 W kg⁻¹, the energy density of ICl₃ can reach 754 Wh kg⁻¹. The maximum energy density of 1024 Wh kg⁻¹ of ICl₃ cannot be achieved by intercalation-type cathode materials (LiCoO₂ and NMC). Furthermore, the achievable power density of ICl₃ is almost two orders of magnitude higher at the same energy density of intercalated cathode materials, such as the NMC.

In summary, the rechargeable Li—Cl₂ battery delivers a high capacity, a high energy density and a high power. In-situ and ex-situ spectroscopy data and calculations reveal that reduced Cl⁻ ions are partially dissolved in the electrolyte, and oxidized Cl⁰ is anchored by forming interhalogen bonds with I. A reversible Li—Cl₂ at room temperature can deliver a specific capacity of 302 mAh g⁻¹ at 425 mA g⁻¹, and a 73.8% capacity retention at 1250 mA g⁻¹. The successful use of ICl₃ in a rechargeable lithium battery paves a new way to develop energy-dense and high-power halogen-based cathode materials.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to +10% of that numerical value, such as less than or equal to +5%, less than or equal to +4%, less than or equal to +3%, less than or equal to +2%, less than or equal to +1%, less than or equal to +0.5%, less than or equal to +0.1%, or less than or equal to +0.05%.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “battery” or “battery system” is a source of electric power consisting of one or more electrochemical cells with external connections for powering electrical devices. When a battery is supplying power, its positive terminal is the cathode and its negative terminal is the anode.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### INDUSTRIAL APPLICABILITY

This invention relates to a direct halogen cathode showing high reversibility without using an intermediary material. The ICl₃ cathode is ideal for Li—Cl₂ batteries due to highly redox active and reversible during the breakage and reformation of interhalogen bonds between I and Cl. The developed Li—Cl₂ batteries would be commercially competitive hold superior energy density, power density and cycle durability and are highly competitive in the further market.

1. A high capacity, high energy density and high power reversible Li—Cl₂ battery system, comprising:
a halogen-based cathode;
an anode;
a separator placed between the halogen-based cathode and the anode; and
an organic electrolyte disposed in a space between the halogen-based cathode and the anode, wherein the halogen-based cathode comprises at least one interhalogen compound including chlorine statically adsorbed to a porous host electrode, and the porous host electrode comprises:
at least one porous material;
a plurality of electrically conductive particles;
a binder; and
a current collector,
wherein the reversible Li—Cl₂ battery system has a capacity of at least 200 mAh g⁻¹, an energy density in a range of 750-1100 Wh kg⁻¹, and a power density in a range of 1400-4500 Wh kg⁻¹ within a current density of 425 to 1250 mA g⁻¹.

2. The Li—Cl₂ battery system of claim 1, wherein Cl-ions are partially dissolved in the organic electrolyte, and Cl⁰ ions are efficiently and chemically anchored by forming interhalogen bonds with I, allowing for a Cl^{0/-1} reaction in a highly reversible manner.

3. The Li—Cl₂ battery system of claim 1, wherein the anode comprises Li plate or Li foil.

4. The Li—Cl₂ battery system of claim 1, wherein the at least one porous material comprises activated carbon (YP50), templated carbons, carbide-derived carbons, carbon nanotubes, carbon aerogels, carbon onions, graphenes and carbon nanofibers.

5. The Li—Cl₂ battery system of claim 1, wherein the at least one interhalogen compound comprises iodine trichloride (ICl₃).

6. The Li—Cl₂ battery system of claim 1, wherein the organic electrolyte comprises one or more mixed solvent with or without additives.

7. The Li—Cl₂ battery system of claim 6, wherein the organic electrolyte is ether-based electrolyte selected from the group consisting of monoglyme, diglyme, triglyme, tetraglyme, or mixed with a volume ratio of 1:1/1:2/1:3/1:4 in a glove box filled with Ar atmosphere.

8. The Li—Cl₂ battery system of claim 1, wherein the organic electrolyte further comprises one or more lithium salt as a solute.

9. The Li—Cl₂ battery system of claim 8, wherein the one or more lithium salts is selected from the group consisting of LiTFSI, LiOTF, LiPF₆, LiClO₄, LiBF₄, LiAsF₆, and LiDFOB.

10. The Li—Cl₂ battery system of claim 6, wherein the additives comprise LiF, LiNO₃, vinylene carbonate (VC), vinyl ethylene carbonate, allyl ethyl carbonate, or Lithium bis(oxalato) borate.

11. The Li—Cl₂ battery system of claim 1, wherein the current collector is selected from the group consisting of carbon cloth, carbon paper, graphite paper, Ti foil/mesh, and stainless steel.

12. The Li—Cl₂ battery system of claim 1, wherein the plurality of electrically conductive particles comprise carbon nanotubes, graphene, conductive carbon black, Super P, acetylene black, and carbon nanofibers.

13. The Li—Cl₂ battery system of claim 1, wherein the binder comprises styrene-butadiene rubber (SBR) and polyvinylidene fluoride (PVDF).

14. The Li—Cl₂ battery system of claim 1, wherein the separator comprises polypropylene/polyethylene/polypropylene (PP/PE/PP) separator, poly(tetrafluoroethylene) (PTFE), poly(vinyl chloride) (PVC) and polyamide (PA).

15. A method for constructing a halogen cathode, comprising:
step (a): mixing at least one porous material with a large Brunauer-Emmett-Teller (BET) surface area, a plurality of electrically conductive particles, and a binder in a solvent to form a first mixture;
step (b): coating the first mixture onto a current collector, and drying in a vacuum oven to construct a porous host electrode; and
step (c): sealing the porous host electrode and ICl₃ in a glass reactor filled with Ar atmosphere, and a ICl₃ cathode is obtained by static adsorption after 12 to 24 hours.

16. The method of claim 15, wherein the BET surface area is in a range of 1500 m² g⁻¹ to 2000 m² g⁻¹.

17. The method of claim 15, wherein the porous host electrode comprises reduced graphene oxide, activated carbon, hollow carbon sphere, and carbon cloth.

18. The method of claim 15, wherein ICl₃ loading is measured by subtracting the mass of the porous host electrode from the ICl₃ cathode, and up to 30 wt % to 90 wt %.
